(19) United States
(12) Patent Application Publication
(10) Pub. No.: US 2026/0120177 A1
(43) Pub. Date: Apr. 30, 2026

(54) REAL TIME UPSTREAM PAYMENT INTERFACE

(71) Applicant: PAYPAL, INC., San Jose, CA (US)

(72) Inventor: Chetan Nadgire, Fremont, CA (US)

(21) Appl. No.: 18/931,243

(22) Filed: Oct. 30, 2024

(51) Int. Cl. G06Q 30/08; G06Q 20/40

(52) U.S. Cl. CPC G06Q 30/08; G06Q 20/4016

(57) ABSTRACT

The disclosed computer-implemented method may include receiving, by a merchant server, user information of a user visiting a merchant website, and sending, from the merchant server to a bidding exchange, a bid request for displaying a payment interface on the merchant website. The bidding exchange may be connected to multiple payment processor servers that may provide payment interface code to the merchant server. The method may also include receiving, by the merchant server from the bidding exchange, the payment interface code in response to the bid request, and presenting, on the merchant website using the payment interface code, a customized payment interface. Various other methods, systems, and computer-readable media are also disclosed.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for a real time upstream payment interface.

FIG. 2 is a block diagram of an example network for a real time upstream payment interface.

FIG. 3 is a diagram of an example merchant website with an upstream payment interface.

FIG. 4 is a diagram of an example payment interface for a merchant website.

FIG. 5 is a diagram of an example real time upstream payment interface.

FIGS. 6A-D are diagrams of an example architecture for a real time bidding engine for a real time upstream payment interface.

FIGS. 7A-B are flow diagrams of example processes for presenting a real-time upstream payment interface.

FIG. 8 is a flow diagram of an example method for a real-time upstream payment interface.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

E-commerce or payment processing services allow users to make online purchases. Advancements in interface design have streamlined the purchasing process. For example, a feature of upstream presentment of a payment button or interface allows presenting the payment button earlier in the user's purchasing process than the final checkout stage.

Traditionally, in e-commerce transactions, users (e.g., customers) visit a merchant (e.g., a merchant's website, app, etc.), browse and add items to their shopping carts. The users would then proceed to checkout and finalize purchases by making a payment. However, with the upstream presentment, the payment button may be presented on product pages themselves or on other stages before the checkout process begins. This approach may streamline the payment process and reduce friction for users, making it easier and quicker for them to make a purchase. By presenting the payment button earlier, users may complete the transaction with fewer steps, potentially leading to improved user experience.

Payment processing services often include features or application programming interfaces (APIs) that allow merchants/businesses to implement upstream payment presentment as part of their checkout flows. However, conventional upstream presentment features have limitations. For example, the merchant and the payment processing service may need to establish a contract or other agreement before implementing upstream presentment, and may further require merchants to incorporate the appropriate API into their website. Incorporating the API in this manner may produce a static upstream presentment, which may not be compatible in certain scenarios. For example, certain web servers may not be configured to support such APIs, or may otherwise require reconfiguration (e.g., modifying server application code and/or website code, developing new apps to support the APIs, etc.). In addition, different user devices of various configurations (e.g., device types, browsers, apps, etc.) may produce configurations in which such APIs may not correctly function and otherwise presents challenges of having support for the different possible configurations. Accordingly, there is a need for a dynamic upstream presentment.

The present disclosure is generally directed to real time upstream presentment. As will be explained in greater detail below, embodiments of the present disclosure may receive an indication of a missing interface element or otherwise a notification of an availability for an interface element, such as a bid request for displaying a payment interface on a product page hosted on a merchant server, and further provide the bid request to payment processor servers, receive bids from the payment processor servers responding to the bid request, and provide the merchant server a payment interface code package after a real time evaluation of the bids. The systems and methods provided herein advantageously allows dynamic updating of an interface (e.g., dynamically updating a product page with a payment interface as the product page is loaded in a user's browser or app). The systems and methods provided herein may improve the functioning of a computer itself by more efficiently processing various factors for real time analysis and dynamically updating an interface. The systems and methods provided herein may further improve internet technology, such as by allowing dynamic updating of a payment interface portion of a website based on custom factors, as well as also improve user interface technology by providing a user-centric payment interface.

Features from any of the embodiments described herein may be used in combination with one another in accordance with the general principles described herein. These and other embodiments, features, and advantages will be more fully understood upon reading the following detailed description in conjunction with the accompanying drawings and claims.

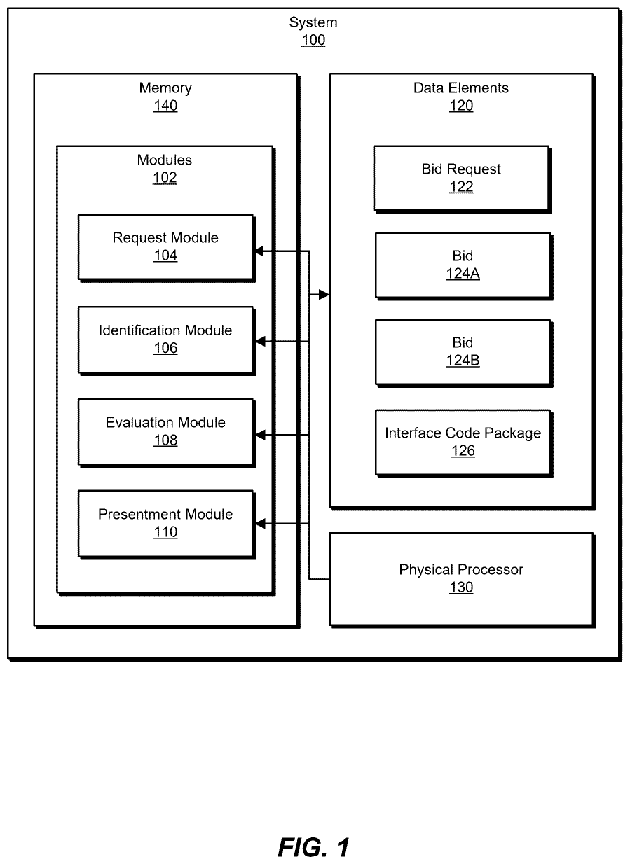

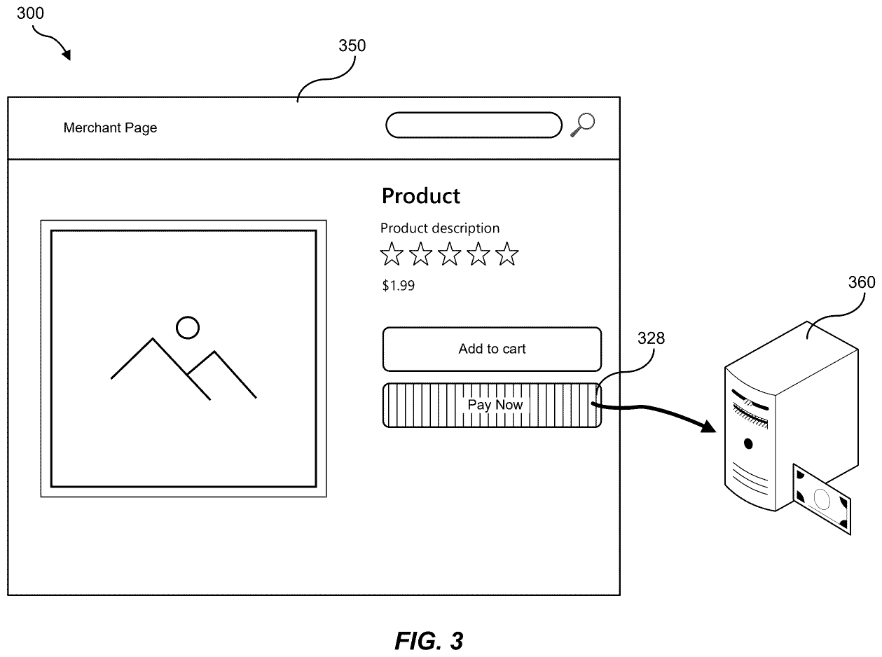

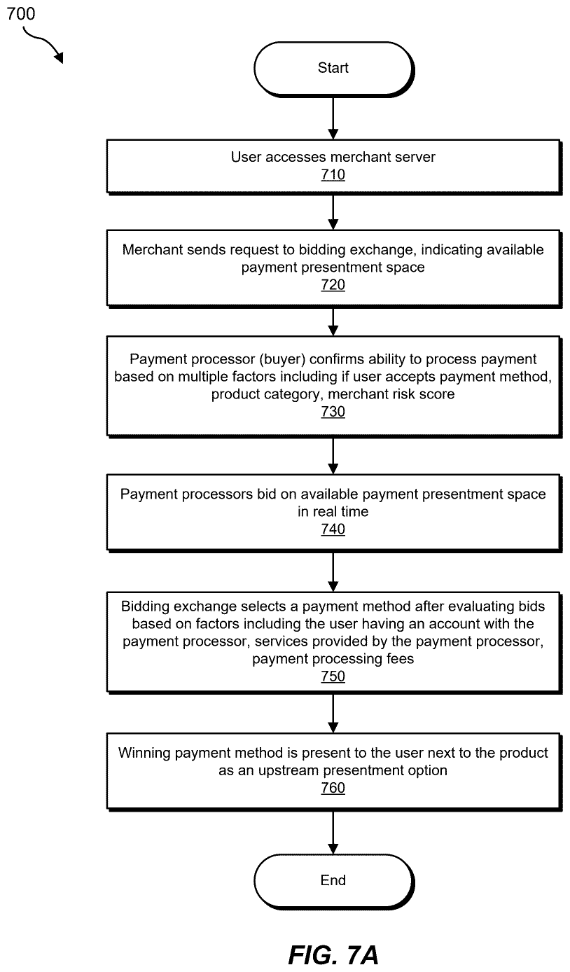

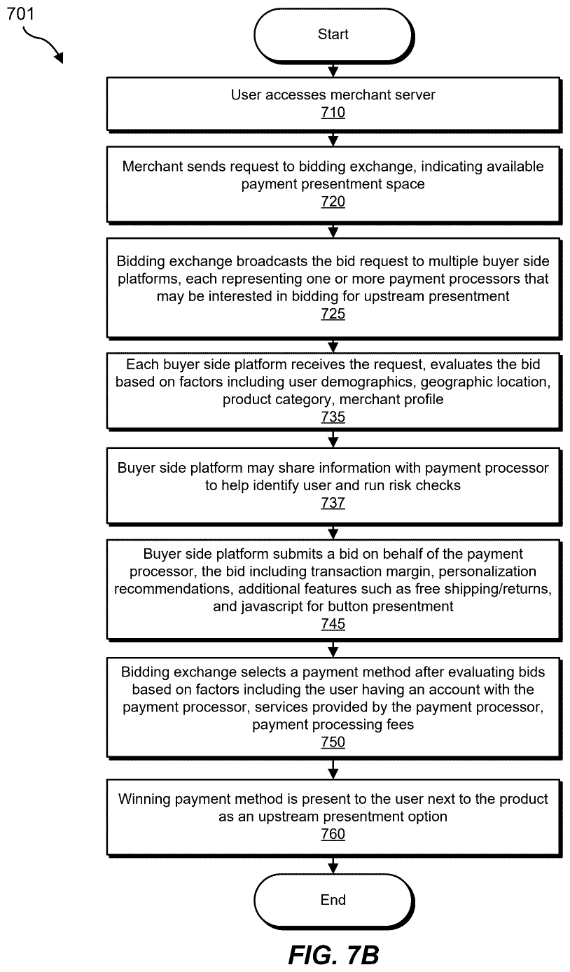

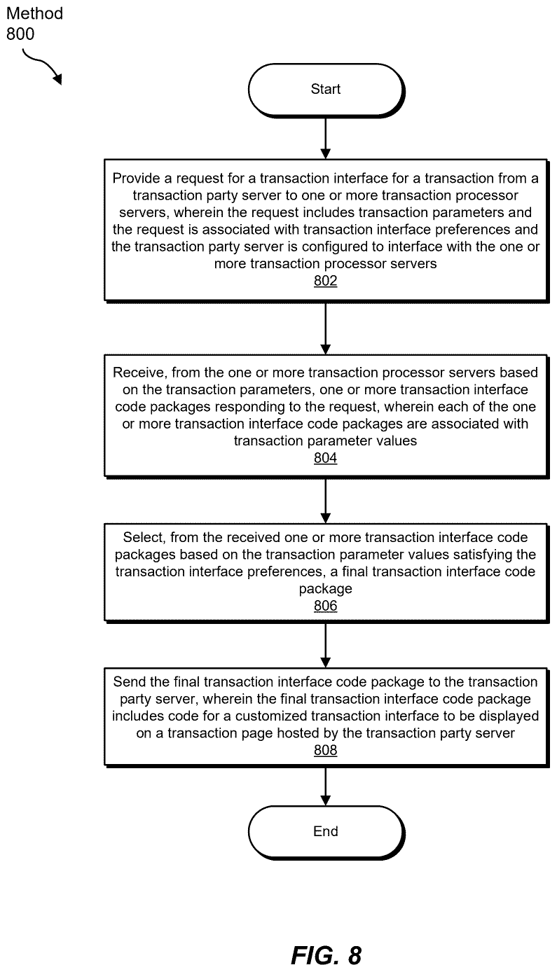

The following will provide, with reference to FIGS. 1-8, detailed descriptions of a real time upstream payment interface. Detailed descriptions of example systems and architectures will be provided in connection with FIGS. 1, 2, and 6A-6D. Detailed descriptions of example interfaces will be provided in connection with FIGS. 3-5. In addition, detailed descriptions of example computer-implemented methods will be provided in connection with FIGS. 7 and 8.

Various systems described herein may perform the processes described herein. FIG. 1 is a block diagram of an example system 100 for a real time upstream payment interface. As illustrated in this figure, example system 100 may include one or more modules 102 for performing one or more tasks. As will be explained in greater detail herein, modules 102 may include a request module 104, an identification module 106, an evaluation module 108, and a presentment module 110. Although illustrated as separate elements, one or more of modules 102 in FIG. 1 may represent portions of a single module or application.

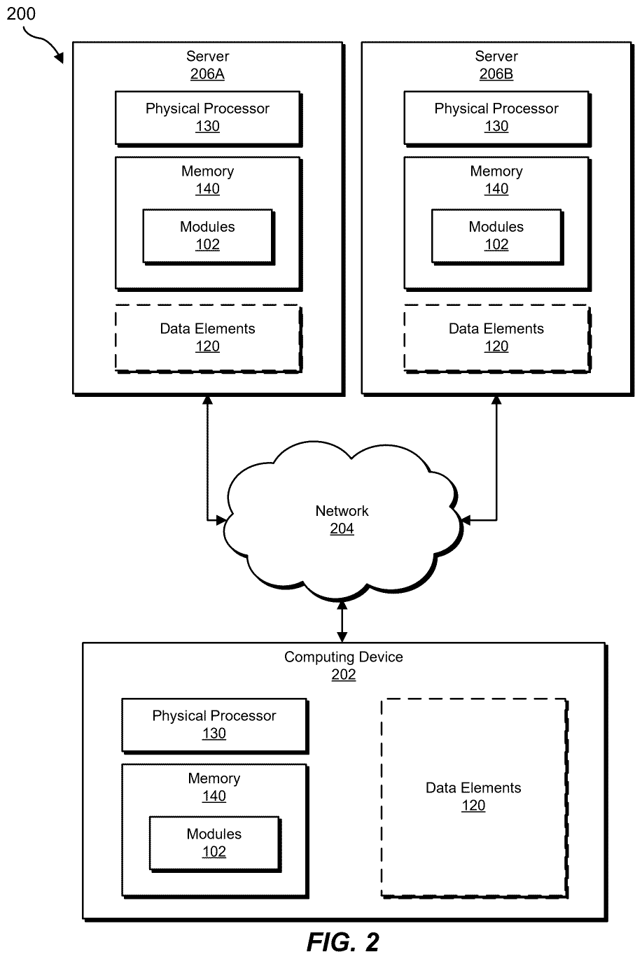

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202, server 206A and/or server 206B). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to real time upstream presentment. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more data elements 120, such as a bid request 122, a bid 124A, a bid 124B, and an interface code package 126. Bid request 122, bid 124A, bid 124B, and/or interface code package 126 may be stored on a local storage device, such as memory 140, or may be accessed remotely. Bid request 122 may represent an indication that an interface element is missing or otherwise that an upstream presentment space is available, and may include or otherwise be associated with related data and/or parameters, as will be explained further below. In addition, the examples herein refer to a bid request in reference to certain scenarios, but in other examples, bid request 122 may generally refer to or otherwise represent an indication of a missing interface element (e.g., a missing element on a web interface such as on a webpage, which may alternatively represent a space on the webpage that is available for an interface element). Bid 124A and bid 124B may each represent responses to bid request 122, which may include proposals to be evaluated with respect to bid request 122, as will be explained further below. Interface code package 126 may represent code (e.g., web code such as HTML, JavaScript, etc.), script, program, etc. for providing a payment interface, and may correspond to a bid selected in response to bid request 122, as will be explained further below.

Example system 100 in FIG. 1 may be implemented in a variety of ways. For example, all or a portion of example system 100 may represent portions of example network environment 200 in FIG. 2.

FIG. 2 illustrates an example network environment 200 implementing aspects of the present disclosure. The network environment 200 includes computing device 202, a network 204, server 206A, and server 206B. Computing device 202 may be a client device or user device, such as a desktop computer, laptop computer, tablet device, smartphone, or other computing device. Computing device 202 may include a physical processor 130, which may be one or more processors, memory 140, which may store data such as one or more of data elements 120. Although not explicitly illustrated, computing device 202 may include one or more input devices (e.g., keyboard, mouse, touchscreen, etc.), a display, and may include browser software or other software for accessing and presenting an interface, such as a web-based merchant interface (e.g., a merchant website for buying products).

Server 206A and server 206B may each represent or include one or more servers capable of hosting, evaluating, and/or communicating data. For example, server 206A and/or server 206B may be a web server for hosting websites. Server 206A and/or server 206B may be servers configured for processing confidential data (e.g., financial transactions), which in some examples may use data from computing device 202. Server 206A and/or server 206B may each include a physical processor 130, which may include one or more processors, memory 140, which may store modules 102, and one or more of additional elements 120.

Computing device 202 may be communicatively coupled to server 206A and/or server 206B through network 204. Network 204 may represent any type or form of communication network, such as the Internet, and may comprise one or more physical connections, such as LAN, and/or wireless connections, such as WAN.

FIG. 3 illustrates an example upstream presentment 300. FIG. 3 includes a product page 350 that may correspond to a product listing of a merchant's website hosted by a merchant server (corresponding to a server such as server 206A and/or server 206B). Product page 350 includes a payment interface 328 that may correspond to a payment service provided hosted by a payment processor server 360 (corresponding to a server such as server 206A and/or server 206B). A payment interface may include one or more interface elements allowing a user to provide transaction details (e.g., user authentication details, payment amount, purchase details such as product/quantity, shipping details, etc.) to a payment processor (e.g., to a server of the payment processor) to conduct a financial transaction. Product page 350 may be presented to a user visiting the merchant's website, and more particularly visiting the indicated product to potentially purchase the product.

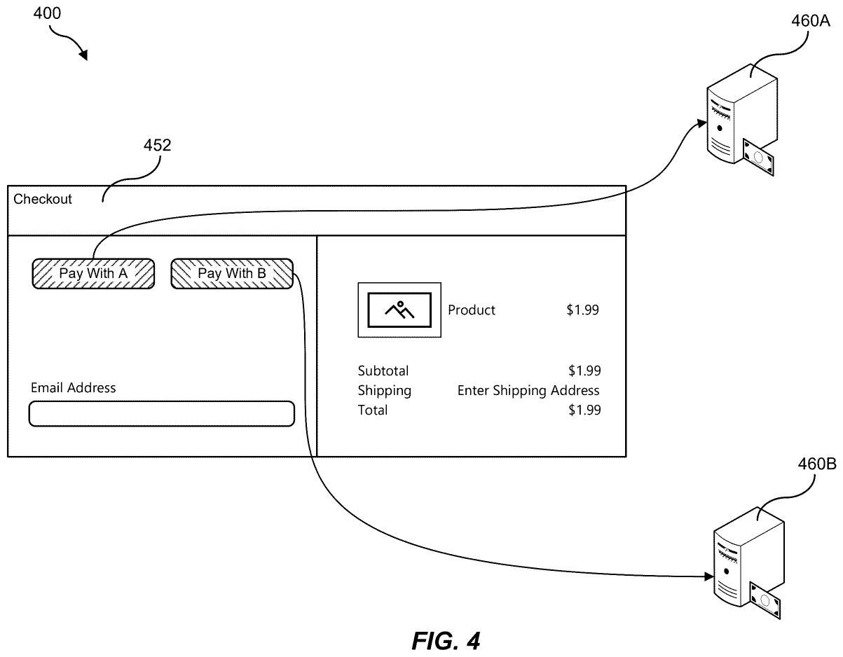

FIG. 4 illustrates an example checkout stage 400, which may correspond to a checkout process. For instance, after the user visits product page 350 and add the product to the cart (e.g., an interface for tracking items that the user has selected for purchase), the user may visit a checkout page 452 to complete a purchase transaction for the product. The merchant may allow the user to complete the transaction using one or more payment processors, represented by a payment processor server 460A (corresponding to a server such as server 206A and/or server 206B) and a payment processor server 460B (corresponding to a server such as server 206A and/or server 206B). Each of payment processor server 460A and payment processor server 460B may be configured to provide financial transaction services. For example, as illustrated in FIG. 4, payment processor server 460A may provide (e.g., as loaded as part of checkout page 452) a first interface (e.g., button) and payment processor server 460B may provide a second interface (e.g., button). By using the appropriate button, the user may select between payment processors for providing payment to finalize the checkout and complete the purchase.

However, as detailed above, such a checkout interface may cause friction for the user to complete the purchase. For example, the user may need to advance through various checkout stages to reach checkout page 452, which may include transaction preview stages. Selecting one of the buttons may further lead to a separate payment interface that may include, for example, logging into or otherwise being authenticated by the payment processor (e.g., by payment processor server 460A and/or payment processor server 460B), as well as other steps necessary for finalizing the purchase (e.g., confirming tax, shipping, etc.).

Returning to FIG. 3, product page 350 provides an upstream presentment of payment interface 328 in that product page 350 presents payment interface 328 before the final checkout stage (e.g., checkout page 452). In other words, the user may access the payment processor's service from product page 350 to streamline the checkout process.

However, as illustrated in FIG. 3, the upstream presentment of payment interface 328 may be limited to a single payment processor (as represented by payment processor server 360). In some examples, the merchant (e.g., product page 350) may not be configured to present payment interfaces from other payment processors that may be desirable to present. For instance, the user may not have an account with the payment processor in FIG. 3 which may not be known unless initiates authentication with payment processor server 360. In this example, the usefulness of the upstream presentment may be greatly reduced, and updating payment interface 328 for that of another payment processor (e.g., that the user may have an account with) after product page 350 has already loaded in the user's browser may be undesirable or otherwise unfeasible.

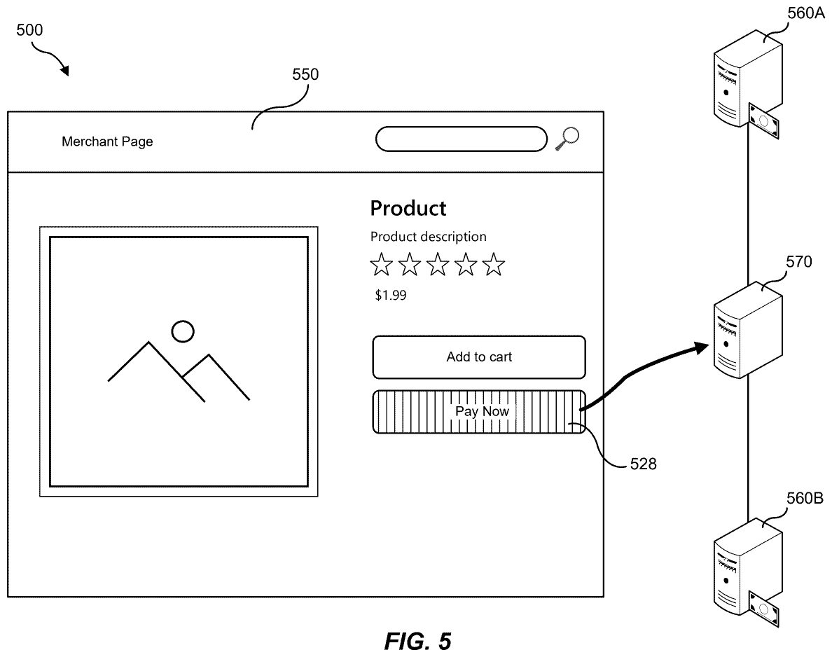

Turning now to FIG. 5, FIG. 5 illustrates a real time upstream presentment 500 of a product page 550 corresponding to product page 350. Similar to product page 350, product page 550 includes an upstream presentment of a payment interface 528. However, in contrast to payment interface 328 loaded from a particular payment processor (e.g., as represented by payment processor server 360), payment interface 528 may be loaded from one of multiple payment processors, as represented in FIG. 5 by a payment processor server 560A (corresponding to a server such as server 206A and/or server 206B) and a payment processor server 560B (corresponding to a server such as server 206A and/or server 206B). A bidding exchange server 570 may dynamically select between payment processors in real time so as to provide payment interface 528 as product page 550 loads, as will be described further below. Accordingly, payment interface 528 allows the user to use the payment processor selected by bidding exchange server 570 (e.g., by connecting to the appropriate server, payment processor server 560A or payment processor server 560B).

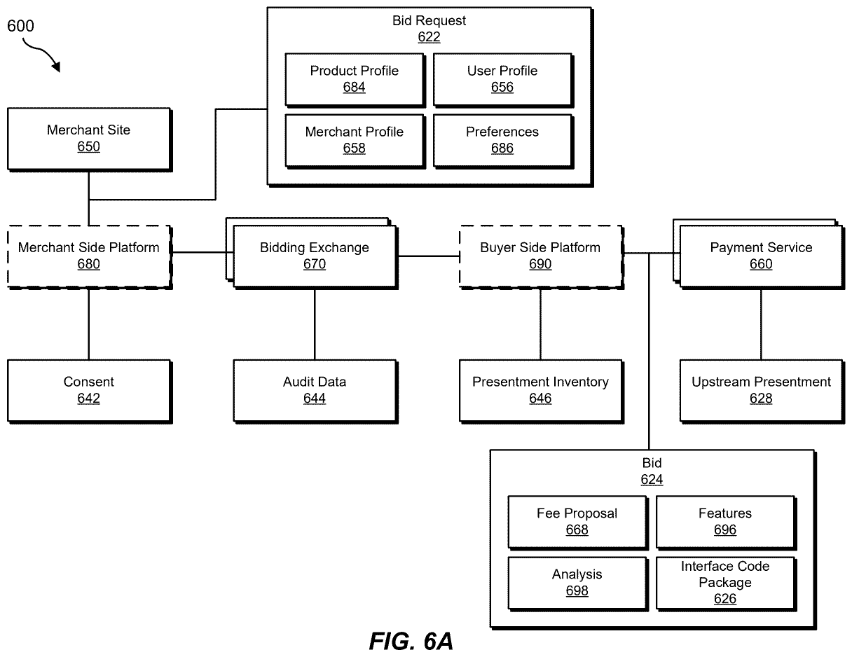

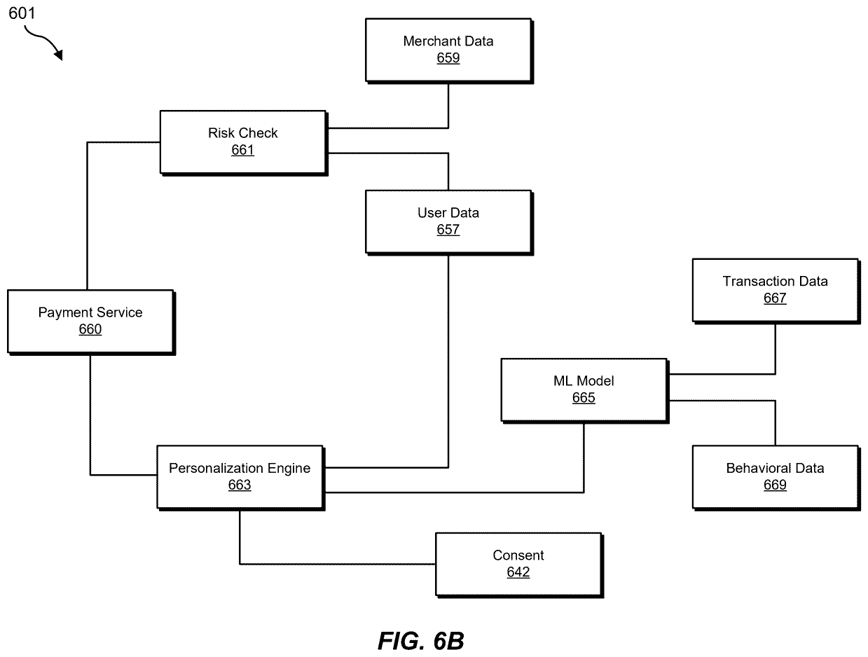

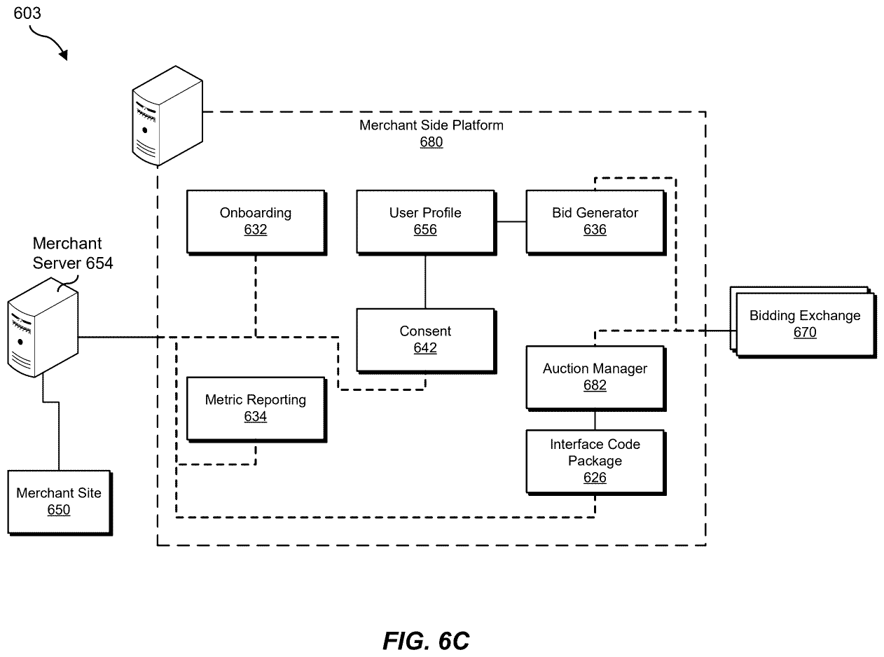

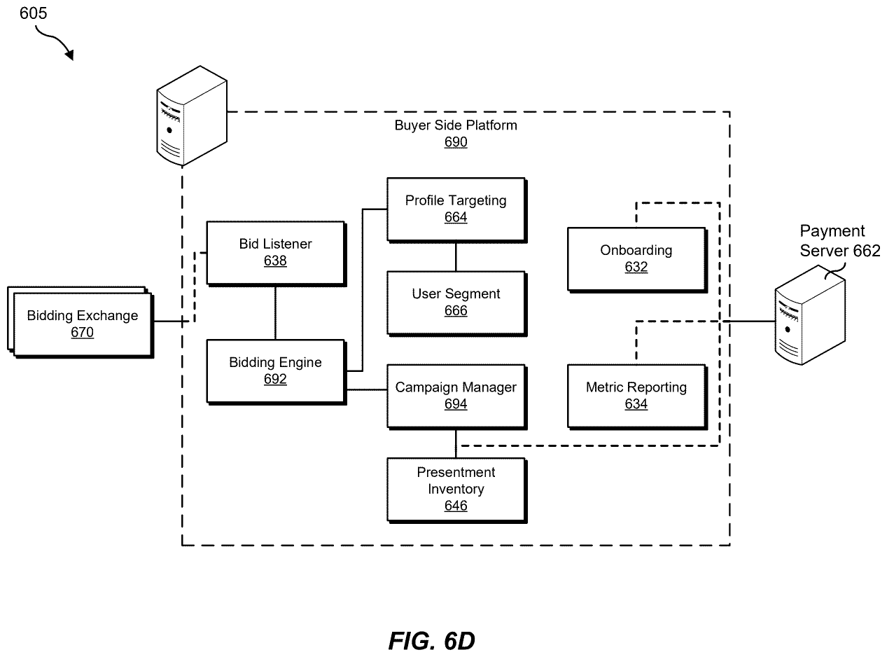

FIGS. 6A-6D illustrate an example architecture of a real time bidding exchange for upstream presentment of a payment interface. FIG. 6A illustrates an overall architecture 600 including a merchant site 650 (corresponding to product page 550), a merchant side platform 680, a consent 642, a bid request 622 (corresponding to bid request 122), one or more bidding exchange 670 (corresponding to bidding exchange server 570), audit data 644, a buyer side platform 690, a presentment inventory 646, one or more payment service 660 (corresponding to payment processors), an upstream presentment 628 (corresponding to payment interface 528), and a bid 624 (corresponding to bid 124). The elements in FIGS. 6A-6D may correspond to computing devices (e.g., computing device 202, server 206A, and/or server 206B) and/or data stored therein.

Merchant site 650 may be hosted on a merchant server 654 (corresponding to a server such as server 206A and/or server 206B), as illustrated in FIG. 6B. Upon a user visiting/loading merchant site 650, merchant server 654 may generate bid request 622 to one or more bidding exchange 670. Bid request 622 may include information that may be used by payment service 660 to provide a response (e.g., bid 624). Bid request 622 may include, for example, a product profile 684, a user profile 656, a merchant profile 658, and preferences 686.

Product profile 684 may correspond to various details regarding the product in the product page visited by the user, including but not limited to a product category, name, description, identifiers (e.g., SKU code), etc. Merchant profile 658 may correspond to various details regarding the merchant (corresponding to merchant site 650) such as merchant name and other identifiers. User profile 656 may correspond to various details about the user visiting merchant site 650, which in some examples may include user name, user account info, location, demographic information, device fingerprint information (e.g., device information, browser information, etc.). In some examples, the user may have control over what information may be passed as user profile 656. For example, consent 642 may indicate whether the user consents to certain information (e.g., identifiable information such as name) is passed. In some examples, if identifiable information is unavailable for user profile 656, such as if the user is browsing incognito or opted out of providing identifiable information, user profile 656 may correspond to cohort information (e.g., information of similar classes of users), such as device info, location info, etc.

Preferences 686 may correspond to merchant preferences for bids, such as preferred parameters for fees, preferences regarding additional features proposed in bids, etc. Although FIG. 6 illustrates preferences 686 as part of bid request 622, in some implementations, preferences 686 may be global (e.g., applying to all bid requests from the merchant) and may be established and stored separately from bid request 622.

Bidding exchange 670 may identify which payment service(s) 660 that the merchant is configured to accept. Merchant site 650 may be configured to integrate with APIs of certain payment processors, which may further relate to which payment processors that the merchant has signed contracts for accepting payments. In some examples, bidding exchange 670 may identify the merchant using merchant profile 658.

Bidding exchange 670 may forward bid request 622 to the identified payment service(s) 660. In some examples, bidding exchange 670 may forward bid request 622 entirely (e.g., product profile 684, merchant profile 658, user profile 656, and/or preferences 686) and/or portions thereof, which may be based on information relevant/useful to a particular payment service 660 (e.g., removing information not needed by the particular payment service 660), and/or be based on user and/or merchant preferences for sending information.

Payment service 660 may evaluate bid request 622. In some examples, payment service 660 may incorporate various analyses and assessments, as illustrated in an example payment service architecture 601 in FIG. 6B. Payment service 660 may perform a risk check 661, for example determining various risk scores, such as a merchant risk score based on merchant profile 658 (as compared to a database of merchant data 659), and a user risk score based on user profile 656 (as compared to a database of user data 657). The merchant risk score may correspond to a reputation of the merchant and represent risk factors for completing the transaction with the merchant (e.g., if the merchant sells prohibited items, the merchant is unknown, the merchant is new, the merchant having a history of poor products/returns, etc.), which may be based on historical data of transactions with the merchant in merchant data 659. The user risk score may correspond to a reputation of the user and represent risk factors for completing the transaction with the user (e.g., risk of being fraudulent and/or compromised, credit score, reliability, tendency to return items, etc.) as well as a likelihood of completing the transaction (e.g., conversion), which may be based on historical data of transactions with the user, if available in user data 657 (e.g., if the user has an account with payment service 660). In other examples, the user risk score may be based on the cohort data, representing a general risk associated with a class relating to the user.

Payment service 660 may also perform additional analysis to provide the merchant with further insights with respect to the potential transaction. For example, a personalization engine 663 may utilize a machine learning (ML) model 665 to provide the merchant with recommendations, such as recommendations for related products the user may be interested in, interface modifications (e.g., placement of graphics/text/user interface elements) that may improve the conversion rate, analytics/insights regarding the user and/or potential transaction, financial product recommendations (e.g., buy now pay later options, financing/credit options, etc.). ML model 665 may correspond to any machine learning model and/or scheme that may be trained on various data, such as transaction data 667 (corresponding to transactions of multiple users), behavioral data 669 (corresponding to how users have responded to previous recommendations, trends, etc.).

In some examples, payment service 660 may perform a consent check to check consent 642 (and/or recordation thereof), indicating which features the user has opted into and restricting analysis/data collection based on what the user has opted out of.

Returning to FIG. 6A, payment service 660 may determine bid 624 which may include a fee proposal 668, features 696, analysis 698, and an interface code package 626. Fee proposal 668 may correspond to a proposed fee for completing the potential transaction, which may be based on a percent of the total transaction amount (e.g., 3%), a flat fee, etc. In some implementations, fee proposal 668 may be determined based on the analysis described herein, such as the merchant risk score, the user risk score, a probability of conversion, etc. Features 696 may correspond to additional features, such as recommendations, products/services, etc., as described herein, that payment service 660 may offer as part of bid 624. Analysis 698 may correspond to insights, recommendations, etc., as described herein, that payment service 660 may also include as part of bid 624. Interface code package 626 may correspond to code/program for providing a payment interface (which in some examples may further be customized for the potential transaction based on the analysis) such that if bid 624 is accepted, merchant site 650 may incorporate interface code package 626 to load the payment interface on the user's browser as upstream presentment 628 (see, e.g., payment interface 528 in FIG. 5).

Bidding exchange 670 may receive multiple bids 624 (e.g., one from each identified payment service 660) and select a final bid (e.g., winning bid) based on the bid contents as well as preferences 686. With respect to fee proposal 668, bidding exchange 670 may incorporate a proxy bidding scheme in which the bids automatically update with respect to each other in real time. For example, fee proposal 668 may correspond to a threshold that payment service 660 is willing to offer, which for percent-based fees, may correspond to a lowest percent. Bidding exchange 670 may evaluate the bids may successively advancing bids (e.g., lowering the percent) by a predetermined amount (e.g., a fraction of a percent, which may also dynamically update as the bidding proceeds). Bidding exchange 670 may eliminate a bid when its threshold is exceeded by another bid, until a final bid remains.

In some examples, bidding exchange 670 may incorporate preferences 686, which may indicate additional preferences/parameters for selecting bids. Preferences 686 may place different weights on different aspects of bids, for example adding weight to features 696 and/or analysis 698 offered by bid 624 beyond fee proposal 668. For example, the merchant may prefer being provided certain recommendations/insights. Accordingly, bidding exchange 670 may select the final bid based on, for instance, a weighted average of the bid contents based on preferences 686. For instance, preferences 686 may provide a tie breaker for two bids having the same/similar fee proposal. In other examples, preferences 686 may place a heavy weight on the features and/or analysis offered such that bidding exchange 670 may not select the final bid based on the best fee proposal.

FIG. 6A further illustrates optional elements such as merchant side platform 680, which will be described in further detail with respect to FIG. 6C, and buyer side platform 690, which will be described in further detail with respect to FIG. 6D. Turning now to FIG. 6C, FIG. 6C illustrates a merchant side architecture 603 of merchant side platform 680 that may facilitate connecting the merchant to one or more bidding exchange 670 as well as provide additional analytical features for the merchant. FIG. 6C includes a merchant server 654 (corresponding to a server such as server 206A and/or server 206B) for hosting merchant site 650. Merchant side platform 680, which may also correspond to a server such as server 206A and/or server 206B, may include onboarding 632, metric reporting 634, user profile 656, consent 642, a bid generator 636, an auction manager 682, and interface code package 626.

Merchant side platform 680 may include onboarding 632 to facilitate the merchant in registering (e.g., establishing contracts) or otherwise connecting to (e.g., integrating APIs, etc.) multiple payment processors, bidding exchanges, and/or buyer side platforms. Metric reporting 634 may provide the merchant with analytics and reporting capabilities to allow merchants to track upstream presentment performance, identify trends, and make data-driven decisions. Merchant side platform 680 may further facilitate privacy compliance, for example managing user profile 656 and consent 642 to protect users'privacy as well as comply with any standards.

Merchant side platform 680 may also manage real time bidding. Bid generator 636 may track inventory (e.g., upstream presentment space on merchant site 650) as well as preferences 686 of the merchant. When an upstream presentment space if available, bid generator 636 may generate bid request 622, determine an appropriate bidding exchange 670, and send bid request 622 to the selected bidding exchange 670. In some examples, bid generator 636 may select more than one bidding exchange 670. Further, bid generator 636 may also provide audience management, such as using user profile 656 for precise targeting.

Auction manager 682 may facilitate winning/final bids, for example selecting between final bids received from multiple bidding exchanges 670 (e.g., acting as a bidding exchange), and facilitate integration of interface code package 626 from the final bid into merchant site 650. Thus, merchant side platform 680 may act as a liaison between merchant server 654 and bidding exchanges 670 to facilitate further integration of merchant site 650 with bidding exchanges 670 without requiring significant reconfiguration of merchant server 654.

An analogous platform for buyers (e.g., payment processors) will be described with respect to FIG. 6D. FIG. 6D illustrates a buyer side architecture 605 of buyer side platform 690 that may be connected to a payment server 662 (corresponding to a server such as server 206A and/or server 206B) for payment service 660. Buyer side platform 690, which may correspond to a server such as server 206A and/or server 206B, includes a bid listener 638, a bidding engine 692, a profile targeting 664, a user segment 666, a campaign manager 694, a presentment inventory 646, onboarding 632, and metric reporting 634.

Bid listener 638 may receive bid request 622 from bid exchange 670 to manage received bid requests for payment server 662. Bidding engine 692 may produce bid 624 for payment service 660 based on various factors. For example, profile targeting 664 and user segment 666 may allow payment service 660 to leverage its user data for bids. Campaign manager 694 may facilitate creating and running campaigns across multiple bidding exchanges 670 and/or merchant side platforms 680 allowing payment service 660 to set bidding strategies and performance goals. Presentment inventory 646 may facilitate tracking upstream presentment spaces available (across different merchants and/or bidding exchanges) and/or previously bid on, which may further provide campaign manager 694 with additional feedback for managing campaigns. Metric reporting 634 may provide analytics and reporting, such as insights into campaign performance and/or comprehensive analytics and reporting per region/exchange/merchant, to payment server 662. Onboarding 632 may facilitate payment service 660 with registering with bidding exchanges and/or merchants.

Thus, buyer side platform 690 may act as a liaison between payment server 662 and bidding exchanges 670, merchant side platforms 680, and/or merchant servers 654 to facilitate further integration of the payment processor without requiring significant reconfiguration of payment server 662.

FIG. 7A is a flow diagram of an example computer-implemented method 700 for real time upstream presentment of a payment interface. The steps shown in FIG. 7 may be performed by any suitable computer-executable code and/or computing system, including the system(s) illustrated in FIGS. 1, 2, and/or 6A-6D. In one example, each of the steps shown in FIG. 7 may represent an algorithm whose structure includes and/or is represented by multiple sub-steps, examples of which will be provided in greater detail below.

As illustrated in FIG. 7A, at step 710 the user accesses a merchant server. For example, the user may access merchant site 650 hosted by merchant server 654.

At step 720 the merchant sends a request to a bidding exchange, indicating available payment presentment space. For example, merchant server 654 may send bid request 622 to bidding exchange 670 in response to step 710 (e.g., in response to the user accessing merchant server 654 in general, the user accessing merchant site 650 and/or specific pages thereof, such as a product page). Merchant server 654 may send bid request 622 to bidding exchange 670 as merchant site 650 initially loads on the user's device. In some examples, bid request 622 may include product profile 684, user profile 656, merchant profile 658, and/or preferences 686, as described herein, which may further vary based on triggering conditions. For example, if the user visited a product page, product profile 684 may include information relating to the visited product page (e.g., product details such as product name, product category, etc.), although if the user visited merchant site 650 more generally, product profile 684 may not include such details. In some examples, the triggering condition may affect a type of interface element requested in bid request 622 and/or preferences 686, such as a payment interface for completing a purchase (e.g., on a product page), an interface for applying for and/or presenting other payment products (e.g., a buy now pay later option, etc., that may be displayed on merchant site 650 more generally). In yet other examples, an availability of information (e.g., user profile 656), may modify bid request 622 and/or preferences 686 (e.g., with more available information, more specific interface elements such as a specific payment product may be requested, whereas less information more general interface elements such as a default payment interface may be requested).

At step 730 the payment processor (e.g., buyer) confirms the ability to process payment based on multiple factors including if the user accepts the payment method, product category, and merchant's risk score. Payment service 660 may automatically evaluate bid request 622 as described herein. For example, using information about the user provided in user profile 656, payment service 660 may identify aspects of the user, such as whether the user has an account with payment service 660, whether the user has already logged into the account with payment service 660 (e.g., in a same session as the user's visit to merchant site 650), the user's transaction history with payment service 660, whether the user has preferred payment methods (e.g., a wallet saved), whether the user has preferred payment products, etc. In some examples, payment service 660 may identify the user based on whether the information available in user profile 656 satisfies a confidence score threshold. In addition, payment service 660 may perform a risk assessment of the user, which may incorporate for example the confidence score, the user's history (e.g., history of risky transactions, cancelled transactions, fraudulent transactions, user's location such as with respect to the merchant's location, user financial and/or credit information, user demographics, etc.). Moreover, payment service 660 may perform a similar analysis of the merchant using merchant profile 658 and product profile 684, such as evaluating a confidence score of identifying the merchant and/or product (as compared to respective confidence score thresholds), identifying a risk potential with the merchant (e.g., the merchant's history of cancelled transactions/returns, the merchant's reputation, product type/category such as certain products being more likely to be returned and/or subject to fraud, the user's history with the merchant and/or product, etc.).

Payment service 660 may also determine bid 624 based on these assessments as well as preferences 686. For example, fee proposal 668 may be a transaction margin value reflecting potential risk involved in the transaction (e.g., based on the user and/or merchant risk). Analysis 698 may include personalization recommendations and/or other user insights available based on historical data from the user's account as may be requested/preferred based on preferences 686. Features 696 may include additional analysis (e.g., product analysis, transaction analysis, etc.) as may be requested/preferred based on preferences 686 along with other features such as free shipping/returns. Interface code package 626 may include code that may be based on, for example, a type of interface requested in bid request 622 and/or preferences 686 (e.g., for a particular payment interface, a general interface element, etc.).

At step 740 the payment processors bid on available payment presentment space in real time. For example, payment services 660 may bid in real time on the available payment presentment space represented by bid request 622 as determined from bid 624. In some examples, bidding exchange 670 may collect respective bids 624 from payment services 660, and using rules that may be established in preferences 686 or otherwise established between the merchant and payment services 660, automatically evaluate bids 624. In one example, each bid 624 may be evaluated and ranked based on preferences 686 (e.g., evaluating fee proposal 668, features 696, analysis 698, and/or interface code package 626 as they relate to preferences 686 for each component, which may further reflect a weighted average for combining the rankings of the components to determine overall rankings). In some examples, a particular component, such as fee proposal 668 may be automatically evaluated, such as by automatically determining a fee based on proxy bidding that automatically increments bids, as described above. In other examples, other rules, heuristics, and/or trigger conditions may be incorporated for evaluating and selecting bid 624. In some examples, preferences 686 may include a preference for payment services 660 for which the user has an account (e.g., as may be indicated in analysis 698 and/or features 696) to improve a likelihood that interface code package 626 is compatible with the user's device and/or may require minimal reconfiguration. Further, in some implementations, bidding exchange 670 may receive multiple rounds of bids 624 from payment services 660, such as by providing feedback to payment services 660 and allow updated bids 624.

At step 750 the bidding exchange selects a payment method after evaluating the bids (see, e.g., step 740) based on factors including the user having an account with the payment processor, services provided by the payment processor, and payment processing fees. For example, bidding exchange 670 may select bid 624 based on the evaluation described herein. Bidding exchange 670 may notify payment service 660 that provided the selected bid 624 as to the selection, which in some implementations allow payment service 660 to configure or otherwise prepare for interface code package 626 to be presented (e.g., by expecting the user to access payment service 660, which may include preparing for the user to log in if needed, reauthorizing an active session of the user with payment service 660, associating a potential transaction with the accepted fee proposal 668, etc.) as well as to provide the merchant with analysis 698 and/or features 696 (e.g., allowing merchant site 650 and/or merchant server 654 to load or otherwise access analysis 698 and/or features 696).

At step 760 the winning payment method is presented to the user next to the product as an upstream presentment option. For example, merchant site 650 may incorporate interface code package 626, similar to product page 550 incorporating payment interface 528 as discussed with respect to FIG. 5. Moreover, as the bidding process herein may occur in real time, and more specifically while merchant site 650 is loading on the user's device (e.g., as discussed with respect to step 710 and step 720), interface code package 626 may load with the rest of merchant site 650 to provide the user with a seamless experience of loading merchant site 650 with a dynamically generated payment interface.

FIG. 7B is a flow diagram of an example computer-implemented method 701 for real time upstream presentment of a payment interface using a buyer side platform for real time upstream presentment of a payment interface. The steps shown in FIG. 7 may be performed by any suitable computer-executable code and/or computing system, including the system(s) illustrated in FIGS. 1, 2, and/or 6A-6D. In one example, each of the steps shown in FIG. 7 may represent an algorithm whose structure includes and/or is represented by multiple sub-steps, examples of which will be provided in greater detail below. Moreover, as will be discussed below, certain steps in FIG. 7B may be similar to analogous steps in FIG. 7A.

As illustrated in FIG. 7B, at step 710 the user accesses a merchant server, similar to step 710 in FIG. 7A. For example, the user may access merchant site 650 hosted by merchant server 654.

At step 720 the merchant sends a request to a bidding exchange, indicating available payment presentment space, similar to step 720 in FIG. 7A. For example, merchant server 654 may send bid request 622 to bidding exchange 670 as described above.

At step 725 the bidding exchange broadcasts the bid request to multiple buyer side platforms, each representing one or more payment processors that may be interested in bidding for upstream presentment. Bidding exchange 670 may broadcast bid request 622 to one or more buyer side platform 690. For example, rather than interfacing with payment services 660 (as in FIG. 7A such as steps 730 or 740), bidding exchange 670 may instead interface with buyer side platforms 690. As discussed above with respect to FIG. 6D, each buyer side platform 690 may be configured to interface with payment server 662 of payment service 660 to manage aspects relating to real time bidding with bidding exchange 670.

At step 735 each buyer side platform receives the request, evaluates the bid based on factors including user demographics, geographic location, product category, merchant profile. For example, buyer side platform 690 receives bid request 622 and evaluates it as described herein such as with respect to FIG. 6D. Further, buyer side platform 690 may perform some of the evaluation and risk assessments described with respect to step 730 in FIG. 7A, rather than payment service 660 in step 730, such as an initial assessment of whether payment service 660 is supported by merchant server 654. Moreover, buyer side platform 690 may perform such evaluation for each payment service 660 associated with buyer side platform 690 (e.g., performing an independent evaluation for each payment service 660, although in some implementations may reuse evaluations for identical assessments as permitted by payment services 660).

At step 737 the buyer side platform may share information with payment processor to help identify user and run risk checks. For example, buyer side platform 690 may provide data to payment server 662. Certain evaluations discussed with respect to step 730 in FIG. 7A may be performed internally to payment server 662, such as assessments using internal data as collected/processed by payment service 660. For example, buyer side platform 690 may provide user profile 656, product profile 684, and/or merchant profile 658 to payment server 662 (that may have passed any initial assessments in step 735) for payment service 660 to perform internal risk assessments as described above with respect to step 730 in FIG. 7A.

At step 745 the buyer side platform submits a bid on behalf of the payment processor, the bid including transaction margin (e.g., fee proposal 668), personalization recommendations (e.g., analysis 698), additional features (e.g., features 696) such as free shipping/returns, and JavaScript (e.g., interface code package 626) for button presentment. For example, buyer side platform 690 may submit bid 624 to bidding exchange 670 (and/or merchant side platform 680) as described herein. For example, rather than payment service 660 submitting bids 624 to bidding exchange 670 as described with respect to step 740 in FIG. 7A, buyer side platform 690 may submit bid 624 to bidding exchange 670.

At step 750 the bidding exchange selects a payment method after evaluating the bids based on factors including the user having an account with the payment processor, services provided by the payment processor, and payment processing fees, similar to step 750 in FIG. 7A. For example, bidding exchange 670 may select bid 624 based on the evaluation described herein.

At step 760 the winning payment method is presented to the user next to the product as an upstream presentment option, similar to step 760 in FIG. 7A. For example, merchant site 650 may incorporate interface code package 626.

FIG. 8 is a flow diagram of an example computer-implemented method 800 for real time upstream presentment of a payment interface. The steps shown in FIG. 8 may be performed by any suitable computer-executable code and/or computing system, including the system(s) illustrated in FIGS. 1, 2, and/or 6A-6D. In one example, each of the steps shown in FIG. 8 may represent an algorithm whose structure includes and/or is represented by multiple sub-steps, examples of which will be provided in greater detail below.

As illustrated in FIG. 8, at step 802 one or more of the systems described herein may provide a request for a transaction interface for a transaction from a transaction party server to one or more transaction processor servers, wherein the request includes transaction parameters and the request is associated with transaction interface preferences and the transaction party server is configured to interface with the one or more transaction processor servers. For example, request module 104 may provide a transaction request such as bid request 122 to transaction processor servers identified by identification module 106 (e.g., based on registration with the transaction processor server).

The systems described herein may perform step 802 in a variety of ways. In one example, the transaction parameter values may include a transaction fee proposal for the transaction and selecting the final transaction interface code package may be based on evaluating the transaction fee proposals from the one or more transaction interface code packages. In some examples, the transaction parameters may include a transaction party profile corresponding to the transaction party server.

At step 804 one or more of the systems described herein may receive, from the one or more transaction processor servers based on the transaction parameters, one or more transaction interface code packages responding to the request, wherein each of the one or more transaction interface code packages are associated with transaction parameter values. For example, evaluation module 108 may receive bids (e.g., bid 124A and/or bid 124B) that may each include transaction interface code packages (e.g., interface code package 126).

The systems described herein may perform step 804 in a variety of ways. In one example, the one or more transaction interface code packages may each include a transaction feature proposal based on the transaction party profile such that selecting the final transaction interface code package may be based on evaluating the transaction feature proposals from the one or more transaction interface code packages.

In some examples, the transaction feature proposals may correspond to at least one of a transaction risk assessment or a recommendation for modifying the transaction page. In some examples, a transaction risk assessment may include a likelihood of an issue with completing the transaction, such as a likelihood of a fraudulent transaction (e.g., by the user, the merchant, etc.), a likelihood of the transaction failing (e.g., based on the user's credit or ability to pay, the merchant's reputation for completing transactions, likelihood of the user returning the product, etc.). In some examples, the recommendation for modifying the transaction page may include recommendations for different payment products (e.g., buy now pay later options, financing/credit options, offering free shipping/returns, etc.), recommendations for specific types of interfaces (e.g., a particular type of button or other interface element, a graphical design of the interface element, a placement of the interface element, etc.), recommendations for related products and/or how to present the related products, etc.

At step 806 one or more of the systems described herein may select, from the received one or more transaction interface code packages based on the transaction parameter values satisfying the transaction interface preferences, a final transaction interface code package. For example, evaluation module 108 may select interface code package 126 based on evaluating the corresponding bids as described herein, such as described with respect to steps 750 in FIGS. 7A and 7B and further described with respect to FIG. 6A.

The systems described herein may perform step 806 in a variety of ways. In one example, the one or more transaction interface code packages may each include a transaction feature proposal based on the transaction party profile and selecting the final transaction interface code package is based on evaluating the transaction feature proposals from the one or more transaction interface code packages.

At step 808 one or more of the systems described herein may send the final transaction interface code package to the transaction party server, wherein the final transaction interface code package includes code for a customized transaction interface to be displayed on a transaction page hosted by the transaction party server. For example, presentment module 110 may send, and/or incorporate interface code package 126 into a transaction page (e.g., product page 550).

As detailed above, a real-time bidding is a process where an inventory is bought and sold on a per-impression basis via an instant auction that occurs in milliseconds before every webpage loads. A real-time bidding exchange provides a technology platform that facilitates these auctions. It connects a publisher who has a digital space available on their properties e.g. webpage or mobile app, with buyers looking to provide their service to relevant audiences. For upstream payment presentments the publisher corresponds to the merchant who is selling a product through their webpage or mobile app, and the buyer corresponds to the payment company that can present a payment method to the user visiting merchant property and would be interested in purchasing the product.

The systems and methods provided herein allow the merchant to integrate with the real-time bidding exchange, instead of direct integration with a single merchant. This exchange will forward requests from merchants to multiple payment processors. Each payment processor will evaluate the request based on parameters such as a merchant risk score (e.g., a reputation of the merchant and various risk factors of the merchant), a product category (e.g., a product listed on the merchant's page, category, price, etc., and suitable payment options for the product), and a user assessment (e.g., whether the user already has an account with the payment processor, the user's past transactions, and how likely the user is to buy the product).

Based on this evaluation, each payment processor may decide to participate in the upstream payment presentment for the session. If there are bids from more than one payment processor, the exchange may select the best bid based on various factors or let the merchant select the best bid.

Accordingly, the exchange provides a dynamic integration with a payment processor based on which user shows up on the network and the product being purchased. The exchange also allows for new payment processors to participate in the bidding without requiring direct integration with each merchant.

In some aspects, the techniques described herein relate to a system including: a processor; and a non-transitory computer-readable medium having stored thereon instructions that are executable by the processor to cause the system to perform operations including: receiving a bid request from a merchant server for displaying a payment interface on a product page hosted by the merchant server; identifying one or more payment processor servers configured to provide the payment interface to the merchant server; providing the bid request to the one or more payment processor servers; receiving, from the one or more payment processor servers, one or more real-time bids responding to the bid request; evaluating the received one or more real-time bids collectively to determine a final bid, wherein the one or more real-time bids automatically update with respect to each other; and sending the final bid to the merchant server, wherein the final bid includes a payment interface code package for displaying the payment interface on the product page.

In some aspects, the techniques described herein relate to a system, wherein the bid request includes at least one of a merchant profile corresponding to the merchant server, a user profile corresponding to a user visiting the product page, or a product profile corresponding to the product page.

In some aspects, the techniques described herein relate to a system, wherein the user profile is based on non-personal data.

In some aspects, the techniques described herein relate to the system, wherein the non-personal data corresponds to cohort data of a class of users similar to the user visiting the product page.

In some aspects, the techniques described herein relate to a system, wherein determining the final bid is further based on merchant preferences for one or more additional features included in a real-time bid.

In some aspects, the techniques described herein relate to a system, wherein the one or more additional features includes a potential transaction analysis that is based on at least one of the merchant profile, the user profile, or the product profile.

In some aspects, the techniques described herein relate to a system, wherein the one or more additional features includes a potential transaction risk corresponding to the product page that is based on at least one of the merchant profile, the user profile, or the product profile.

In some aspects, the techniques described herein relate to a system, wherein the one or more additional features includes a recommendation for modifying the product page that is based on at least one of the merchant profile, the user profile, or the product profile.

In some aspects, the techniques described herein relate to a system, wherein the one or more real-time bids each include a fee proposal associated with the payment interface, and determining the final bid is based on a proxy bidding scheme using the fee proposals from the one or more real-time bids.

In some aspects, the techniques described herein relate to a system, wherein the payment interface code package includes code for presenting a customized payment interface to connect with the one or more payment processor servers that provided the final bid.

In some aspects, the techniques described herein relate to a method including: providing a request for a transaction interface for a transaction from a transaction party server to one or more transaction processor servers, wherein the request includes transaction parameters and the request is associated with transaction interface preferences and the transaction party server is configured to interface with the one or more transaction processor servers; receiving, from the one or more transaction processor servers based on the transaction parameters, one or more transaction interface code packages responding to the request, wherein each of the one or more transaction interface code packages are associated with transaction parameter values; selecting, from the received one or more transaction interface code packages based on the transaction parameter values satisfying the transaction interface preferences, a final transaction interface code package; and sending the final transaction interface code package to the transaction party server, wherein the final transaction interface code package includes code for a customized transaction interface to be displayed on a transaction page hosted by the transaction party server.

In some aspects, the techniques described herein relate to a method, wherein the transaction parameter values include a transaction fee proposal for the transaction and selecting the final transaction interface code package is based on evaluating the transaction fee proposals from the one or more transaction interface code packages.

In some aspects, the techniques described herein relate to a method, wherein the transaction parameters include a transaction party profile corresponding to the transaction party server.

In some aspects, the techniques described herein relate to a method, wherein the one or more transaction interface code packages each include a transaction feature proposal based on the transaction party profile and selecting the final transaction interface code package is based on evaluating the transaction feature proposals from the one or more transaction interface code packages.

In some aspects, the techniques described herein relate to a method, wherein transaction feature proposals correspond to at least one of a transaction risk assessment or a recommendation for modifying the transaction page.

In some aspects, the techniques described herein relate to a non-transitory computer-readable medium having stored thereon instructions that are executable by a processor of a computing system to cause the computing system to perform operations including: receiving, by a merchant server, user information of a user visiting a merchant website; sending, from the merchant server to a bidding exchange, a bid request for displaying a payment interface on the merchant website, wherein the bidding exchange is connected to one or more payment processor servers configured to provide a payment interface code to the merchant server and the bid request includes at least a portion of the user information; receiving, by the merchant server from the bidding exchange, the payment interface code in response to the bid request; and presenting, on the merchant website using the payment interface code, a customized payment interface.

In some aspects, the techniques described herein relate to a non-transitory computer-readable medium, wherein the operations further include operations for sending, to the bidding exchange, one or more bid preferences corresponding to at least one of a fee preference or a transaction feature preference, and wherein the bidding exchange sends the payment interface code based on the one or more bid preferences.

In some aspects, the techniques described herein relate to a non-transitory computer-readable medium, wherein the bid request further includes at least one of a merchant profile corresponding to the merchant server, or a product profile corresponding to the merchant website.

In some aspects, the techniques described herein relate to a non-transitory computer-readable medium, wherein the transaction feature preference corresponds to one or more interface recommendations based on at least one of the merchant profile, the portion of the user information, or the product profile.

In some aspects, the techniques described herein relate to a non-transitory computer-readable medium, wherein the payment interface code includes code for incorporating an interface recommendation into the customized payment interface.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive transaction to be transformed, transform the transaction data, output a result of the transformation to provide interface code, use the result of the transformation to produce the interface code, and store the result of the transformation to integrate the interface code. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
receiving a bid request from a merchant server for displaying a payment interface on a product page hosted by the merchant server;
identifying one or more payment processor servers configured to provide the payment interface to the merchant server;
providing the bid request to the one or more payment processor servers;
receiving, from the one or more payment processor servers, one or more real-time bids responding to the bid request;
evaluating the received one or more real-time bids collectively to determine a final bid, wherein the one or more real-time bids automatically update with respect to each other; and
sending the final bid to the merchant server, wherein the final bid includes a payment interface code package for displaying the payment interface on the product page.

2. The system of claim 1, wherein the bid request comprises at least one of a merchant profile corresponding to the merchant server, a user profile corresponding to a user visiting the product page, or a product profile corresponding to the product page.

3. The system of claim 2, wherein the user profile is based on non-personal data.

4. The system of claim 3, wherein the non-personal data corresponds to cohort data of a class of users similar to the user visiting the product page.

5. The system of claim 2, wherein determining the final bid is further based on merchant preferences for one or more additional features included in a real-time bid.

6. The system of claim 5, wherein the one or more additional features comprises a potential transaction analysis that is based on at least one of the merchant profile, the user profile, or the product profile.

7. The system of claim 5, wherein the one or more additional features comprises a potential transaction risk corresponding to the product page that is based on at least one of the merchant profile, the user profile, or the product profile.

8. The system of claim 5, wherein the one or more additional features comprises a recommendation for modifying the product page that is based on at least one of the merchant profile, the user profile, or the product profile.

9. The system of claim 1, wherein the one or more real-time bids each comprise a fee proposal associated with the payment interface, and determining the final bid is based on a proxy bidding scheme using the fee proposals from the one or more real-time bids.

10. The system of claim 1, wherein the payment interface code package includes code for presenting a customized payment interface to connect with the one or more payment processor servers that provided the final bid.

11. A method comprising:
providing a request for a transaction interface for a transaction from a transaction party server to one or more transaction processor servers, wherein the request includes transaction parameters and the request is associated with transaction interface preferences and the transaction party server is configured to interface with the one or more transaction processor servers;
receiving, from the one or more transaction processor servers based on the transaction parameters, one or more transaction interface code packages responding to the request, wherein each of the one or more transaction interface code packages are associated with transaction parameter values;
selecting, from the received one or more transaction interface code packages based on the transaction parameter values satisfying the transaction interface preferences, a final transaction interface code package; and
sending the final transaction interface code package to the transaction party server, wherein the final transaction interface code package includes code for a customized transaction interface to be displayed on a transaction page hosted by the transaction party server.

12. The method of claim 11, wherein the transaction parameter values comprise a transaction fee proposal for the transaction and selecting the final transaction interface code package is based on evaluating the transaction fee proposals from the one or more transaction interface code packages.

13. The method of claim 11, wherein the transaction parameters comprise a transaction party profile corresponding to the transaction party server.

14. The method of claim 13, wherein the one or more transaction interface code packages each comprise a transaction feature proposal based on the transaction party profile and selecting the final transaction interface code package is based on evaluating the transaction feature proposals from the one or more transaction interface code packages.

15. The method of claim 14, wherein transaction feature proposals correspond to at least one of a transaction risk assessment or a recommendation for modifying the transaction page.

16. A non-transitory computer-readable medium having stored thereon instructions that are executable by a processor of a computing system to cause the computing system to perform operations comprising:
receiving, by a merchant server, user information of a user visiting a merchant website;
sending, from the merchant server to a bidding exchange, a bid request for displaying a payment interface on the merchant website, wherein the bidding exchange is connected to one or more payment processor servers configured to provide a payment interface code to the merchant server and the bid request includes at least a portion of the user information;
receiving, by the merchant server from the bidding exchange, the payment interface code in response to the bid request; and
presenting, on the merchant website using the payment interface code, a customized payment interface.

17. The non-transitory computer-readable medium of claim 16, wherein the operations further comprise operations for sending, to the bidding exchange, one or more bid preferences corresponding to at least one of a fee preference or a transaction feature preference, and wherein the bidding exchange sends the payment interface code based on the one or more bid preferences.

18. The non-transitory computer-readable medium of claim 17, wherein the bid request further comprises at least one of a merchant profile corresponding to the merchant server, or a product profile corresponding to the merchant website.

19. The non-transitory computer-readable medium of claim 18, wherein the transaction feature preference corresponds to one or more interface recommendations based on at least one of the merchant profile, the portion of the user information, or the product profile.

20. The non-transitory computer-readable medium of claim 19, wherein the payment interface code includes code for incorporating an interface recommendation into the customized payment interface.
